(19) United States
(12) Patent Application Publication
(10) Pub. No.: US 2013/0092636 A1
(43) Pub. Date: Apr. 18, 2013

(54) INSTALLATION OF FILTER ELEMENTS IN A CONTAINER

(71) Applicants: Maria Festner, Wiesbaden (DE); Simon Floren, Waldbrunn (DE)

(72) Inventors: Maria Festner, Wiesbaden (DE); Simon Floren, Waldbrunn (DE)

(73) Assignee: BRITA GMBH, Taunusstein (DE)

(21) Appl. No.: 13/700,193

(22) PCT Filed: May 25, 2011
(86) PCT No.: PCT/EP2011/058585

§ 371 Date: Dec. 19, 2012

(30) Foreign Application Priority Data
May 27, 2010 (DE) 10 2010 029 405.5

(51) Int. Cl. B01D 27/14

(52) U.S. Cl. CPC B01D 27/142
USPC 210/767; 210/346

(57) ABSTRACT

A filter unit for treating water, having a first plate-shaped filter element and at least one second plate-shaped filter element. The first and second filter elements are mutually spaced from each other and define an intermediate space. Each of the first arid second filter elements extends, with reference to a Cartesian coordinate system, along a first spatial axis to a considerably lesser extent than along the two remaining spatial axes such that the element has a layer thickness (ρ). Flow can take place through the first and second filter elements along a path that corresponds to the layer thickness.

### FIELD OF THE INVENTION

The invention relates to a filter unit for treating water, comprising: a first planar filter body; and at least one second planar filter body, wherein the first and the second filter bodies are arranged spaced apart from each other and delimit an intermediate space, and wherein each of the first and second filter bodies extends, with reference to a Cartesian coordinate system, over a considerably shorter distance along a first spatial axis than along the two remaining spatial axes, so that it has a layer thickness (ρ).

The invention further relates to a container for treating water.

The invention also relates to a use of a filter unit.

### BACKGROUND OF THE INVENTION

Although drinking water as taken from the local water network usually has a high quality in respect of its purity, it is not uncommon for it nevertheless to contain substances damaging to health, such as heavy metals or microorganisms. In order to remove these, various methods are known, for example the irradiation of the drinking water to be treated with UV radiation, which leads to an inactivation of the microorganisms. Furthermore, the use of activated carbon recommends itself, in order, for example, to remove microorganisms and heavy metals. An example of a treatment system for drinking water using activated carbon is shown in WO 2004/113232.

Activated carbon in the form of a granulate is frequently used in the containers mentioned at the outset. The water to be treated is put into the container, runs through the bed of granulated activated carbon and then leaves the container again. The granules have the property that their particle size can be selected such that an effective treatment of the drinking water becomes possible. The smaller the particles used, the better is the treatment. However, it is not possible to prevent a small part of the activated carbon particles from escaping from the container and ending up in the treated water, which is undesired. The extent of egress of particles increases with decreasing particle size.

Furthermore, U.S. Pat. No. 4,753,728 shows a altered, cylindrical filter body made of activated carbon, which is provided with an inner layer and an outer layer with different respective permeabilities. Due to the filter body's being sintered, egress of particles is prevented. However, the filter area is limited, so that the volume flow through the filter body is likewise limited.

In comparison with coarser particles, the use of smaller particles permits the same treatment performance while using less raw material; at the same time, the required installation volume in the container decreases. As also described in WO 2004/113232, the escape of fine particles can be reduced by the particles' being enveloped in a very fine-mesh fabric. However, finer particles cause a greater flow resistance, which is of disadvantage in particular in gravity-driven treatment systems. In particular, the time required to treat the drinking water thereby increases.

U.S. Pat. No. 5,308,703 discloses an assembly for adsorption, which comprises at least two sheet absorbents which are arranged in layers so as to form a space between the adjacent sheets, each of the sheet-like adsorbents comprising a heat-conductive sheet and at least one adsorbent sheet containing an adsorbing agent and is arranged on at least one surface of the heat-conductive sheet in contact therewith. The adsorbing sheet is a sintered body made of activated carbon with a density of not less than 0.4 g/cm³. The heat-conductive sheet is a metal sheet.

The fluid to be treated must flow past the sheet-like adsorbents, parallel to the latter. In particular where the spacing between the adjacent adsorbents is too large or the dimensions thereof parallel to the direction of flow are too small, complete treatment does not occur.

### SUMMARY OF THE INVENTION

It is an object underlying the invention to provide a filter unit of the type mentioned at the outset with a relatively effective action and a relatively high volume flow under given pressure conditions.

According to a first aspect, the filter unit according to the invention is characterised in that flow can take place through the first and the second filter bodies along a path corresponding to the layer thickness.

This path is relatively short.

The volume flow \dot{V} through the filter unit can be defined as follows:

$$\dot{V} = \frac{k \cdot Δ p \cdot A}{ρ}$$

Here, k is the permeability, Δp is the pressure difference between the pressure of the water at the entry face and the exit face of the filter unit, A is the filter area and ρ is the layer thickness. The reciprocal of the permeability constitutes the flow resistance through the filter unit. The filter area A is that area through which the water to be treated flows.

The two variables permeability k and flow resistance

$$\frac{1}{k}$$

compare to one another analogously to electrical resistance and electrical conductivity.

The volume flow \dot{V} through the filter unit decreases with increasing layer thickness ρ of the filter unit, while Δp in the case of a gravity-driven system is determined by the hydrostatic conditions in the container. In the case of a pressure-driven system, Δp is determined, for example, by the flow pressure in the water conducts. It follows from the above equation that both a reduction in the flow resistance

$$\frac{1}{k}$$

and an enlargement of the filter area A and a reduction in the layer thickness ρ bring about an increase in the volume flow \dot{V} through the filter unit.

Here, “planar” is to be understood to mean a filter body which, with reference to a Cartesian coordinate system, extends over a considerably shorter distance along one spatial axis than along the two remaining spatial axes. In other words, the filter body has a low thickness or layer thickness and for example, can be shaped like a parallelepiped, a cube or a disc. The lower the layer thickness, the lower also is the flow resistance. Since the water to be treated consequently flows through the filter body along a relatively short path, the flow resistance can be kept low on account of the planar configuration; at the same time the filter area can be enlarged, so that the volume flow through the filter unit is increased.

In one embodiment, flow can take place through the first and the second filter body in the direction of the intermediate space along a path corresponding to the layer thickness.

The treated water therefore leaves the filter unit via the intermediate space. The water to be treated is supplied to the filter unit from two sides.

In one embodiment, the planar filter bodies are sintered filter bodies.

Sintering permits the production of stable filter bodies, which can also be manufactured in the shape of a plate. At least one of the filter bodies may consist essentially only of a sinterable material that is inert with respect to the water. Thus, a filter body can be manufactured with relatively fine pores. It can thereby take on a mechanical filtration function. Filter bodies with such small pores cannot be produced in an injection-moulding process or only with a very large effort.

In one embodiment, the filter unit is configured in the form of a sandwich structure.

The sandwich structure for treating water therefore comprises a first, in particular sintered, planar filter body and a second, in particular sintered, planar filter body, which are arranged spaced apart from each other and delimit an intermediate space. The sandwich structure can be produced before its installation in a container for treating water and subsequently be installed in the desired position. An outlet of this container can then be located in the intermediate space between the activated carbon filters, so that atmospheric pressure prevails here and a pressure gradient towards the intermediate space is generated. The water consequently flows in the direction of the intermediate space. In this configuration, too, the filter area is enlarged in that a unit volume of the water to be treated is able to flow through two filter bodies without the flow resistance increasing, which in turn further reduces the time required for the treatment.

The intermediate space can be an empty space which, for example, is produced by means of spacers, such that the two filter bodies are arranged at a defined distance to each other. This produces an effect, in particular during the production, since the two filter bodies do not come into contact with each other during sintering and are not adhered to each other.

In an embodiment, the sandwich structure comprises a cover layer for sealing off an end face of the filter body.

The end face or the end faces, depending on the geometric shape of the filter body, are those faces which represent the smaller areas in the planar configuration of the filter body. In order to ensure a largely uniform level of treatment, the time needed by the water to flow through the activated carbon filter must be as uniform as possible. If the water enters into the activated carbon filter through the end or the ends, it needs a different time than if it enters via the filter areas. The cover layer prevents the penetration of the water via the end face and ensures that the water enters only via the filter areas. Thus, a uniform level of treatment is established.

In one embodiment, the cover layer covers and seals off the intermediate space.

Were the water able to enter directly into the intermediate space, it would not be treated. The cover layer ensures that the water can only reach the intermediate space after it has flowed through the filter bodies and thereby been treated.

In an embodiment, a drainage layer is arranged in the intermediate space. In this way, it is possible to devise a sandwich structure, the stability of which is still higher than that of the embodiments described above. The layer thickness of the filter bodies can be reduced still further, whereby the raw material requirements decrease further. During the production of the sandwich structure, the drainage layer has the function of keeping the neighbouring filter bodies spaced apart. The drainage layer is formed from a material which on the one hand does not decompose during the sintering process and on the other hand does not lead to any appreciable increase in the flow resistance.

The drainage layer may be an empty space or a sheet structure. An empty space can be produced, for example, by means of spacers, such that the two filter bodies are arranged at a defined distance to each other.

In a variant of this embodiment, the drainage layer has a thickness, and the layer thickness is two to three times as large as the thickness.

This ratio of the thickness of the intermediate space to the layer thickness has proven to be effective on the one hand for the required treatment time of the water and on the other hand for the stability of the sandwich structure.

In an embodiment, the drainage layer is a sheet structure, in particular a textile sheet structure, more particularly a textile sheet structure made of a non-woven material, a knitted material or a woven material.

A sheet structure is to be understood to mean any structure that comprises fibres of any desired type. In particular, the sheet structure is a textile sheet structure made of a non-woven material, knitted material or woven material. The sheet structure may comprise polyester or consist of polyester. Both non-woven materials and knitted materials or woven materials can be produced cost-effectively and are distinguished by good chemical and mechanical stability, in particular if they are permanently moist. This applies to a particular extent to non-woven materials, knitted materials and woven materials made of polyester. Furthermore, non-woven materials, knitted materials and woven materials can be provided with good permeability, so that they do not generate a high flow resistance. Polyester is not decomposed during a sintering process.

In an embodiment, the sheet structure comprises fibres which are at least one of chemically and physically active. These may be activated carbon non-wovens or nano-aluminium fibres, which adsorb particles. Furthermore, fibres that treat the water chemically, for example in the form of ion exchange, may be provided. Thus, the drainage layer participates in the treatment process of the water, which can consequently be configured more effectively.

In an embodiment, at least one of the filter bodies is at least partly covered by a stabilisation covering.

This stabilisation covering may in particular be a on-woven or woven fabric covering, with which at least the filter faces are covered. The stabilisation covering is chosen such that it has high tensile strength. If the filter body is loaded by bending, the stabilisation covering absorbs the tensile forces that arise and reduces the risk of fracture of the filter body.

In an embodiment, the planar filter bodies comprise at least one material from the group comprising activated carbon and ion exchange material.

Such a planar filter body therefore comprises activated carbon or ion exchange material or a mixture thereof, or consists of activated carbon or ion-exchange material or a mixture thereof. Activated carbon has a very high active surface, on which undesired constituents of the water to be filtered can be adsorbed. Water softening can be performed with the aid of the ion-exchange material, for example. Both materials are amenable to sintering and thus to being crafted into filter bodies.

In an embodiment, at least one of the filter bodies has a permeability that varies within the filter body.

In a variant, the permeability varies along a first longitudinal axis of the filter body. A change in the permeability brings about a change in the time the water to be treated requires to pass through the filter body. The required time is a measure of the level of treatment of the water. Provided that an identical pressure acts on the filter body, the level of treatment is higher the longer the water needs to flow through the filter body. This embodiment is particularly suitable for arrangement in a container for treating water, which container has a second longitudinal axis, the first and second longitulongitudinal axes extending essentially in parallel to each other. In the case of gravity-driven containers, the planar filter body is arranged essentially vertically in its intended orientation, and the water to be treated flows through the filter body in an essentially horizontal direction. The containers of filter systems common in the trade typically extend further in the axial direction, that is to say, along the above-defined second longitudinal axis, than in the radial direction. If the second longitudinal axis of the container is aligned parallel to the effective direction of gravity, the hydrostatic pressure changes along the second longitudinal axis. If the first and second longitudinal axes extend in parallel to each other, the hydrostatic pressure changes in a corresponding way along the first longitudinal axis of the filter body. Consequently, different flow times through the filter body will be given rise to. By means of an appropriately adjusted permeability gradient along the first longitudinal axis, the flow time can be kept constant over the entire filter body. The permeability may be adjusted, for example, via the density of the filter body.

In an embodiment of the filter unit, the layer thickness of at least one of the filter bodies changes along a first longitudinal axis.

As already explained, in the case of gravity-driven containers, the hydrostatic pressure increases with the height of the water column that stands above the bottom wall of the container. If the planar filter body is installed vertically, the hydrostatic pressure changes along the first longitudinal axis of the filter body, so that different flow times would occur. As described above, the volume flow \dot{V} through the filter unit decreases with increasing layer thickness ρ of the filter body. By means of the varying layer thickness, the changing hydrostatic pressure can be taken into account. For example, the layer thickness may increase with increasing hydrostatic pressure. Alternatively, a layer thickness decreasing with hydrostatic pressure may also be provided. This can be of use if one wishes to empty the containers as far as possible after ending the treatment operation.

In an embodiment, at least one of the filter bodies is profiled. It may, for example, be provided with spherical protrusions or recesses. In this way, the filter surface is enlarged, such that an increased filtration volume flow can be achieved and the time for treating the water can be reduced.

In a variant, the filter body is profiled in a wave-shaped or saw tooth-shaped manner.

According to another aspect, the container according to the invention for treating water comprises at least one filter unit according to the invention.

The container may further comprise the following: a wall which delimits a container interior space, wherein the at least one filter unit for filtering the water is arranged in the container interior space and the container interior space is subdivided into a supply section and a discharge section; supply means for supplying the water to the supply section of the container interior space; and an outlet arranged at least partly in the wall of the container for carrying off the water out of the discharge section of the container interior space.

The outlet is located in the intermediate space between the filter bodies, so that atmospheric pressure prevails here and a pressure gradient towards the intermediate space is generated. Consequently, the water flows in the direction of the intermediate space. In this configuration, the filter area is again increased, in that a unit volume of the water to be treated can now flow through two or more filter bodies without the flow resistance increasing, which in turn further reduces the time required for the treatment. The intermediate space can be an empty space which, for example, is produced by means of spacers, so that the two filter bodies are arranged at a defined distance to each other. This produces an effect, in particular during the production, since the two filter bodies do not come into contact with each other during sintering and are not adhered to each other.

In an embodiment of the container, the supply section is filled with granulate.

This granulate may likewise consist of activated carbon or ion-exchange material or of another material suitable for water treatment, so that the water to be filtered is already subjected to a purification treatment in the supply section. The degree of treatment is thus increased. Arranging the granulate in the supply section also has the effect that the granulate cannot be discharged out of the container via the outlet, since it is held back by the filter unit. The granulate may be constituted such that it does not float on the water to be filtered.

In an embodiment of the container, the filter unit covers the outlet.

In particular if a cover layer for sealing off an end face of the filter body is provided, it is not necessary for any covering to be provided for the drainage section, since this is formed by the cover layer.

in an embodiment, recesses into which at least one of the filter bodies can be inserted are provided in the wall.

These recesses have a guiding and positioning function, so that they facilitate the insertion of the filter bodies into the container. Irrespective of the size and shape of the container, they can have the same dimensions, so that the filter bodies need be produced in only one size but are nevertheless insertable into different containers. For example, given an appropriate configuration of the recesses, a container extending conically can be fitted with a filter body that is not provided with a conical shape corresponding to that of the container. Thus, the flexibility of manufacturing of the containers according to the invention is increased.

In an embodiment of the container, a sealing layer is provided between the wall and at least one of the filter bodies.

This layer can on the one hand serve to attach the filter body to the container and on the other hand prevents the water to be treated from passing through between the wall and the filter body. This part would then not be treated. Consequently, the sealing layer has a sealing function and ensures the treatment of the whole of the water with which the container is charged.

In an embodiment, the outlet further comprises a channel extending through the container interior space, to which the at least one filter unit is attached, which channel has openings for carrying off the filtered water.

In this embodiment, the filter unit and the channel can be prefabricated and inserted into the container as a structural unit, which reduces the manufacturing and assembly effort.

An embodiment comprises a supporting unit, attachable to the channel and communicating with the openings for arranging the at least one filter unit in the container interior space.

The supporting unit simplifies the arrangement of the filter unit in the container interior space, so that manufacturing and assembly are simplified. Furthermore, the supporting unit and the channel can be produced in one piece, for example by means of an injection-moulding process.

In an embodiment, the container is configured as a cartridge.

The cartridge represents an embodiment of the container that comprises a holding means and sealing means. The cartridge can be inserted into a cup in which the filtered water is collected. The cup can have an outlet, with which the filtered water can be transferred conveniently and without pouring into, for example, a drinking vessel. The holding means permit the simple replacement of the cartridge, for example when the filter unit is exhausted. The sealing means prevents unfiltered water from reaching the cup.

In an embodiment, the filter bodies have a first longitudinal axis and the container has a second longitudinal axis, the first longitudinal axes and the second longitudinal axis extending essentially in parallel to each other.

In the case of gravity-driven containers, the planar filter body is arranged essentially vertically in their intended orientation, and the water to be treated flows through the filter body in an essentially horizontal direction. The containers of containers common in the trade typically extend further in the axial direction, that is to say, along the second longitudinal axis defined above, than in the radial direction. This arrangement of the planar filter body in the container has the effect that the water to be treated can be presented with a larger filter area, which leads to an increased filtration volume flow. The filter area is the area of the filter body through which the water flows. Thus, this arrangement of the filter body in the container ensures better utilisation of the installation volume present in the container and a reduction in the time required to treat the water.

“Essentially parallel to each other” is to be understood in this connection to mean that one aims from a manufacturing point of view to produce an appropriate alignment of the filter body with respect to the longitudinal axis of the containers, wherein a certain deviation is put up with. However, in another embodiment of the container, the first and the second longitudinal axis can deviate considerably from an orientation parallel to each other, wherein the water to be treated nevertheless flows through the filter body in an essentially horizontal direction and the container interior space is subdivided into a supply section and a discharge section by the filter unit.

In an embodiment, the filter bodies have a first longitudinal axis, and the container has a second longitudinal axis, wherein the first longitudinal axes extend essentially at right angles to the second longitudinal axis.

In the intended orientation of the gravity-driven container, an essentially horizontal orientation of the filter bodies thus results. In this embodiment, several filter units can be arranged one above the other, so that the whole of the height of the container interior space can be utilized, so that the available installation volume is utilized effectively and a large filter area is made available.

In an alternative embodiment of the container, the filter bodies have a first longitudinal axis and the container has a second longitudinal axis, wherein the first longitudinal axes and the second longitudinal axis enclose an angle between 0° and 90°.

Through the choice of angle α, the filter area can be enlarged, which leads to an increase in the volume flow through the filter unit. Consequently, the time needed to treat a unit volume decreases.

A further aspect of the present invention concerns the use of a filter unit according to the invention for treating water.

Furthermore, in accordance with a separate aspect, a container for treating water is disclosed below, comprising: a wall which delimits a container interior space, a filter unit for filtering the water, arranged in the container interior space, which subdivides the container interior space into a supply section and a discharge section; supply means for supplying the water to the supply section of the container interior space; and an outlet arranged at least partly in the wall of the container for carrying off the water out of the discharge section of the container interior space, wherein the filter unit comprises a planar filter body.

This container is characterised in that the supply section is filled with a granulate. It may optionally comprise a filter unit according to the invention.

The filter body may be sintered.

In the container, the planar filter body may comprise activated carbon or ion-exchange material or a mixture thereof or consist of activated carbon or ion-exchange material or a mixture thereof.

The filter body of the container may have a first longitudinal axis, and the container may have a second longitudinal axis, wherein the first longitudinal axis and the second longitudinal axis extend essentially in parallel to each other.

The planar filter body of the container may have a permeability, wherein the permeability varies within the filter body.

The filter unit may have a layer thickness, wherein, the layer thickness changes along the first longitudinal axis. In particular, the filter body may be profiled. More particularly, the filter body may be profiled in a wave-shaped or saw tooth-shaped manner.

The filter body may comprise two or more filter bodies spaced apart from one another, which delimit an intermediate space. In particular, a drainage layer may be arranged in the intermediate space.

The intermediate space may have a thickness, wherein the layer thickness is two to three times as large as the thickness.

The drainage layer may be a sheet structure, in particular a textile sheet structure made of a non-woven material, a knitted material or a woven material, wherein the sheet structure may comprise polyester or consist of polyester. In particular, the sheet structure may comprise chemically and/or physically active fibres.

Recesses, into which the filter body can be inserted, may be provided in the wall of the container.

Furthermore, a sealing layer may be applied between the wall and the filter body.

Optionally, the filter body comprises a stabilisation covering, with which it is at least partly covered.

In the container, a cover layer may be applied to seal off an end face of the filter body. In particular, the cover layer may cover and seal off the intermediate space.

In an embodiment of the container, the filter unit covers the outlet.

In an embodiment of the container, the filter unit comprises two or more filter bodies spaced apart from one another, and the filter bodies have a first longitudinal axis and the container has a second longitudinal axis, wherein the first longitudinal axis and the second longitudinal axis extend essentially at right angles to each other.

In the container, the filter unit may comprise two or more filter bodies spaced apart from one another, and the filter bodies may have a first longitudinal axis and the container may have a second longitudinal axis and enclose an angle, wherein the angle is between 0 and 90°.

Furthermore, the outlet may comprise a channel extending through the container interior space, to which channel the filter unit is attached and which is provided with openings for carrying off the filtered water.

The container may be provided with a support unit, attachable to the channel and communicating with the openings, for arranging the filter unit in the container interior space.

The container may also be configured as a cartridge.

The outlet may be arranged in the side wall, and the filter body may be arranged upstream of the outlet, wherein the first and the second longitudinal axes extend essentially in parallel to each other.

### BRIEF DESCRIPTION OF THE DRAWINGS

The invention will be described in detail on the basis of embodiments with reference to the attached drawings, in which:

FIG. 1 shows a plan view of a first exemplary embodiment of a container for treating water;

FIG. 2 shows a side view of the first exemplary embodiment along the cross-sectional plane A-A defined in FIG. 1;

FIG. 3 shows a side view of the first exemplary embodiment along the cross-sectional plane B-B defined in Fig, 1;

FIG. 4 shows a plan view of a second exemplary embodiment of a container for treating water;

FIG. 5 shows a side view of the second exemplary embodiment of the container along a cross-sectional plane which corresponds to the cross-sectional plane A-A defined in FIG. 1;

FIG. 6 shows a plan view of a third exemplary embodiment of a container for treating water;

FIG. 7 shows a side view of the third exemplary embodiment along the cross-sectional plane D-D defined in FIG. 6;

FIG. 8 shows a plan view of a fourth exemplary embodiment of a container for treating water;

FIG. 9 shows a plan view of a fifth exemplary embodiment of a container for treating water; and

FIG. 10 shows a plan view of a sixth exemplary embodiment of a container for treating water;

FIG. 11 shows an isolated representation of a sandwich structure;

FIG. 12 shows a plan view of a seventh exemplary embodiment of a container for treating water;

FIG. 13 shows a side view of the seventh exemplary embodiment shown in FIG. 12 along the cross-sectional plane E-E defined in FIGS. 12; and

FIG. 14 shows a side view of an eighth exemplary embodiment of a container for treating water.

### DETAILED DESCRIPTION OF THE INVENTION

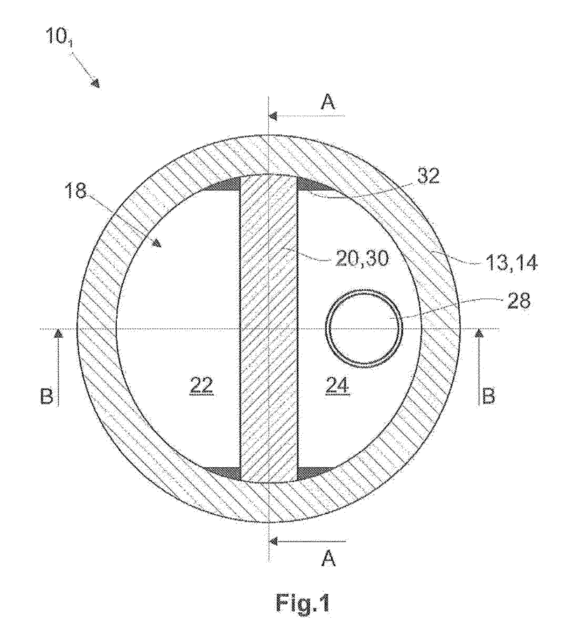

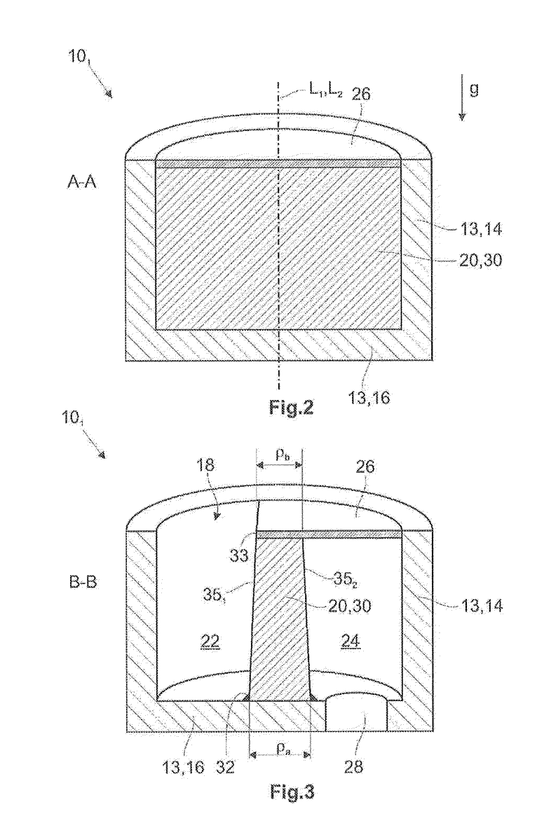

The exemplary embodiment shown in FIG. 1 shows a container 10₁ for treating water, which is provided with a wall 13 with a side wall 14 and a bottom wall 16 (cf. FIG. 2) that delimit a container interior space 18. The bottom wall 16 may however become superfluous through an appropriate choice of the wall 13, for example when the wall 13 is configured conically or in the shape of a pyramid. In the illustrated example, the container 10₁ is provided with a circular cross-section but all other cross-sections are conceivable, for example polygonal or elliptical cross-sections. Arranged in the container interior space 18 is a filter unit 20, which subdivides the container interior space 18 into a supply section 22 and a discharge section 24. The supply section 22 is to be understood to mean the section of the container interior space 18 that is charged with untreated water, i.e. water which has not yet flowed through the filter unit 20. In a corresponding way, the discharge section 24 is the section of the container interior space 18 in which there is treated water, which therefore has already passed through the filter unit 20.

Furthermore, the container 10₁ comprises supply means 26, with the aid of which the untreated water is led into the supply section 22. In the simplest case, this is a covering which covers the discharge section 24 whilst leaving the supply section 22 open (cf. FIG. 3). The supply means 26 could also be configured as flexible tubes or funnels.

Arranged in the discharge section 24 is an outlet 28, via which the treated water is able to leave the container 10₁. By definition, the outlet 28 should be part of the discharge section 24. The filter unit 20, which comprises a sintered, planar filter body 30, is fixed to the side wall 14 and the bottom wall 16 (cf. FIG. 3) and sealed off with respect to them by a sealing layer 32. The sealing layer has both an adhesive and a sealing effect.

FIG. 2 shows a side view along the cross-sectional plane A-A as defined in FIG. 1. The planar filter body 30 has a first longitudinal axis L₁, and the container 10₁ has a second longitudinal axis L₂. As is apparent from FIG. 2, the two longitudinal axes L₁ and L₂ coincide. in the case of gravity-driven containers 10, the two longitudinal axes L₁, L₂ extend along the effective direction of gravity g in the intended orientation, so that an essentially vertical arrangement of the planar filter body 30 results.

FIG. 3 shows a side view along the cross-sectional plane B-B as defined in FIG. 1. The filter body 30 has a layer thickness ρ, which in the illustrated exemplary embodiment varies from the layer thickness ρₐ at the bottom wall 16 to the layer thickness ρ_{b} at the supply means 26. In this case, the layer thickness ρ decreases from to ρ_{b}. However, a change in the layer thickness ρ is not imperative, as is apparent from FIG. 7, for example. It is also apparent that the supply means 26 cover not only the discharge section 24 but also an end face 33 of the filter body 30.

For the treatment of water, the water to be treated is supplied to the container 10 in a suitable way. This can be done, for example, by means of a vessel which has an opening into which the container can be inserted (not illustrated). The supply means 26 ensure that the water to be treated can reach only the supply section 22 of the container interior space 18. The supply section 22 is filled with the water to be treated, so that a positive pressure is built up here, which ensures that the water flows through the filter unit 20, in this case the filter body 30. In addition to the end faces 33, the filter body 30 is provided with two filter areas 35₁ and 35₂, via which the water to be treated enters the filter body 30 and leaves it again. In the illustrated example, the water to be treated enters into the filter body 30 via the filter area 35₁ and leaves it via the filter area 35₂, so that the water to be treated flows through the filter body 30 essentially at right angles to the first longitudinal axis L₁ thereof, whereby it is treated. After flowing through the filter body 30, the water passes into the discharge section 24 and then leaves the container 10 via the outlet 28. As explained above, the supply means 26 also covers the end face 33 of the filter body 30. This prevents that water to be treated is able to enter into the filter body 30 via the end face 33. The water to be treated can consequently enter into the filter body 30 only via the filter area 35₁, which leads to its having to cover a defined minimum distance through the filter body 30, whereby a mini mal level of treatment is ensured.

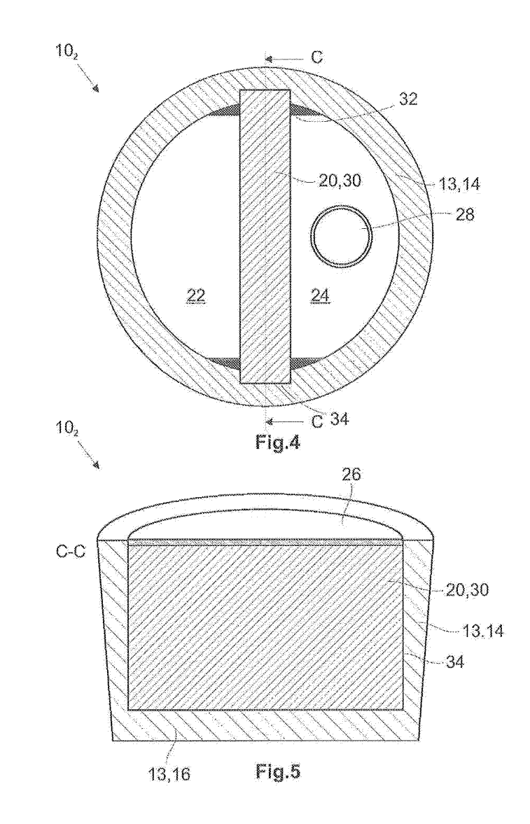

FIG. 4 shows a further exemplary embodiment of a container 10₂ for treating water, which largely corresponds to the exemplary embodiment of FIGS. 1-3. The side wall 14 has recesses 34, into which the filter body 30 is inserted. In FIG. 5, the exemplary embodiment of the container 10₂ illustrated in FIG. 4 is illustrated along the cross-sectional plane C-C defined in FIG. 4. The recesses 34 can be configured such that, for example, the filter body 30 illustrated in FIGS. 1-3 can also be inserted into the container 10₂, even though the latter has a conical shape.

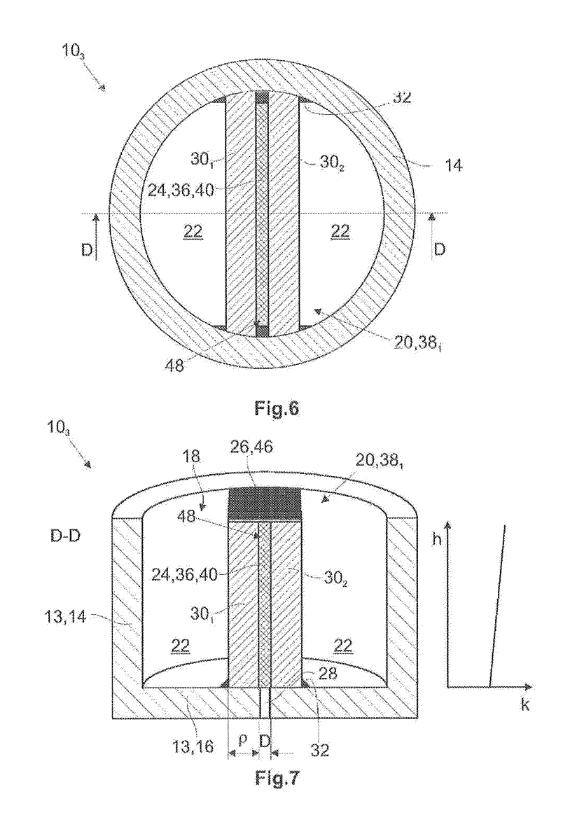

FIGS. 6 and 7 show a container 10₃ for treating water, which is provided with a wall 13 with a side wall 14 and a bottom wall 16 delimit a container interior space 18. The bottom wall 16 can, however, become superfluous through an appropriate choice of the wall 13, for example when the wall 13 is configured conically or in the shape of a pyramid. In the illustrated example, the container 10 is provided with a circular cross-section, but all other cross sections are conceivable, for example polygonal or elliptical cross-sections. Arranged in the container interior space 18 is a filter unit 20, which subdivides the container interior space 18 into a supply section 22 and a discharge section 24. The supply section 22 is to be understood to mean the section of the container interior space 18 which is charged with untreated water, i.e. water which has not yet flowed through the filter unit 20. In a corresponding way, the discharge section 24 is the section of the container interior space 18 in which there is treated water, which therefore has already passed through the filter unit 20.

Furthermore, the container 10₃ comprises supply means 26, with the aid of which the untreated water is led into the supply section 22. This is a cover which covers the discharge section 24, whilst leaving the supply section 22 open. This cover 24 will be explained further below. The supply means 26 could also be configured as flexible tubes or funnels.

Arranged in the discharge section 24 is an outlet 28, via which the treated water is able to leave the container 10₃. By definition, the outlet 28 should be part of the discharge section 24. The filter unit 20 is fixed to the side wall 14 and the bottom wall 16 and sealed off with respect to them by a sealing layer 32. The sealing layer has both an adhesive and a sealing effect.

For the treatment of water, the water to be treated is supplied to the container 10 in a suitable way. This can be done, for example, by means of a vessel which has an opening into which the container can be inserted (not illustrated). The supply means 26 ensure that the water to be treated can reach only the supply section 22 of the container interior space 18. The supply section 22 is filled with the water to be treated, so that a positive pressure is built up here, which ensures that the water flows through the filter unit 20.

The exemplary embodiment of the container 10₃ illustrated in FIGS. 6 and 7 is provided with two filter bodies 30₁ and 30₂ which are arranged spaced apart from each other in the container interior space 18 and delimit an intermediate space 48. Arranged in this intermediate space 48 is a drainage layer 36, wherein the intermediate space 48 may also however remain free. In the exemplary embodiment illustrated in FIGS. 6 and 7, the filter unit 20 is configured as a sandwich structure 38₁, which is formed by the two filter bodies 30₁ and 30₂ and the drainage layer 36. The sandwich structure 38₁ can be produced to a finished state before it is inserted into the container 10₃.

As is apparent from FIG. 7, the drainage layer 36 is arranged over the outlet 28. Thus, in this case, the drainage layer 36, together with the outlet 28, forms the discharge section 24 of the container interior space 18 and fills the latter with the exception of the outlet 28. The drainage layer 36 may be designed as a non-woven layer 40 but is only optional, can therefore also be omitted. Furthermore, the sandwich structure comprises a cover layer 46, which covers both the two filter bodies 30₁ and 30₂ and also the free space 48 and/or the drainage and non-woven layer 36, 40 and seals them off. The cover layer 46 prevents that the water to be treated enters the filter body 30 via the end face and is able to reach the intermediate space untreated. In this case, the cover layer 46 forms the supply means 26, so that the water to be treated can be introduced into the container interior space 18 without any further restrictions. Consequently, the water to be treated flows through each filter body 30₁, 30₂ essentially at right angles to the first longitudinal axis thereof, whereby it is treated. Since the water to be treated can enter into a filter body only via the filter area, it has to cover a defined minimum distance through the filter body 30, whereby a minimal level of treatment is ensured. After flowing through the filter body 30, the water passes into the discharge section 24 and then leaves the container 10 via the outlet 28.

Furthermore, the filter bodies 30₄ and 30₂ illustrated in FIG. 7 have a permeability k which changes over the height h of the filter bodies 30₁ and 30₂, the height h being measured starting from the bottom wall 16. In the example illustrated, the penileability k increases with the height h. Thus, it is possible to take into account the height-dependent hydrostatic pressure, which decreases with height h, when a specific volume of the water to be filtered is present in the container 10₃.

The planar filter bodies 30₁ and 30₂ have a first longitudinal axis, and the container 10₃ has a second longitudinal axis. As is apparent from FIG. 7, the two longitudinal axes coincide. In the case of gravity-driven containers 10, the two longitudinal axes extend along the effective direction of gravity g in the intended orientation, so that an essentially vertical arrangement of the planar filter bodies 30₁ and 30₂ results.

Each of the filter bodies 30₁ and 30₂ has a layer thickness ρ. In a variant of the embodiment illustrated in FIGS. 6 and 7, the layer thickness ρ changes from a first layer thickness at the bottom wall 16 to a second layer thickness ρ at the supply means 26. For instance, the layer thickness ρ decreases from the first to the second layer thickness. It can also be seen that the supply means 26 cover not only the discharge section 24 but also an end face 33 of the filter body 30.

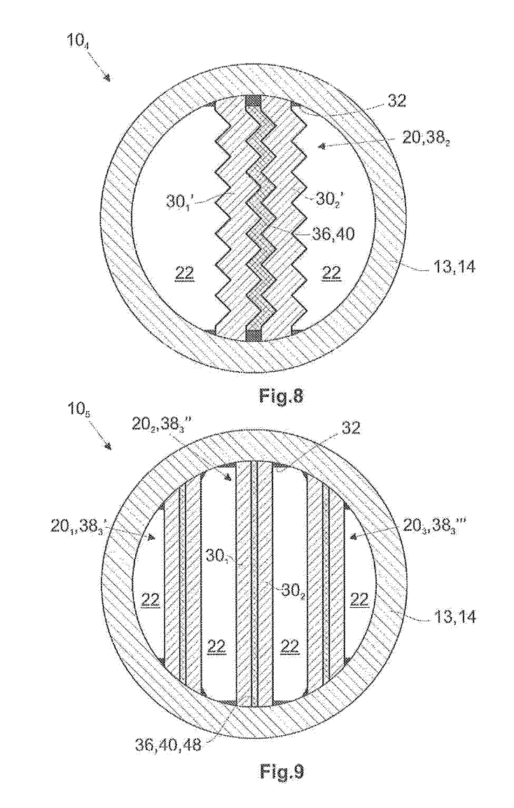

The exemplary embodiment of the container 10₄ illustrated in FIG. 8 is provided with two structured filter bodies 30₁′, 30₂′. In this case, they are structured in a saw tooth-shape but other structurings that lead to an increase in the filter area are conceivable. The drainage layer 36 matches the structure of the activated carbon bodies 30′ and together with the filter bodies 30₁′ and 30₂′, forms the sandwich structure 38₂. Depending on the production method, the filter bodies 30′ are structured through completely, as illustrated, so that they are provided with the structure both on the side which faces the drainage layer 36 and also on the side which faces the supply or discharge section 22, 24. Alternatively, the structure can be omitted on the side which faces the drainage layer 36.

A further exemplary embodiment of the container 10₅ is illustrated in FIG. 9, in which a total of three filter units 20₁-20₃ in the form of sandwich structures 38₃-38₃′″, each having a drainage layer 36, is provided. In principle, the number of filter bodies 30 is not limited to a specific number. Furthermore, some or all of the drainage layers 36 can be omitted. An individual outlet 28 (not illustrated) is provided under each drainage layer 36.

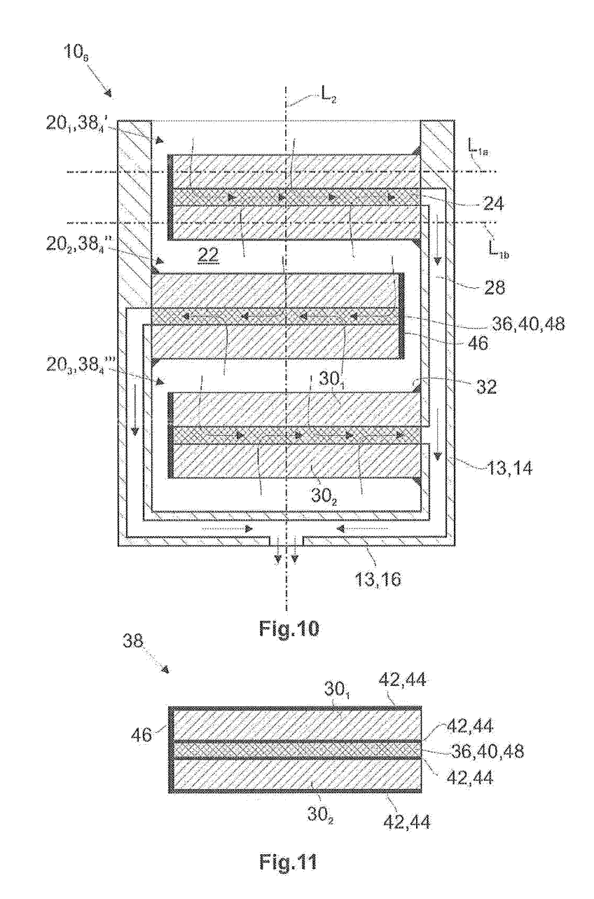

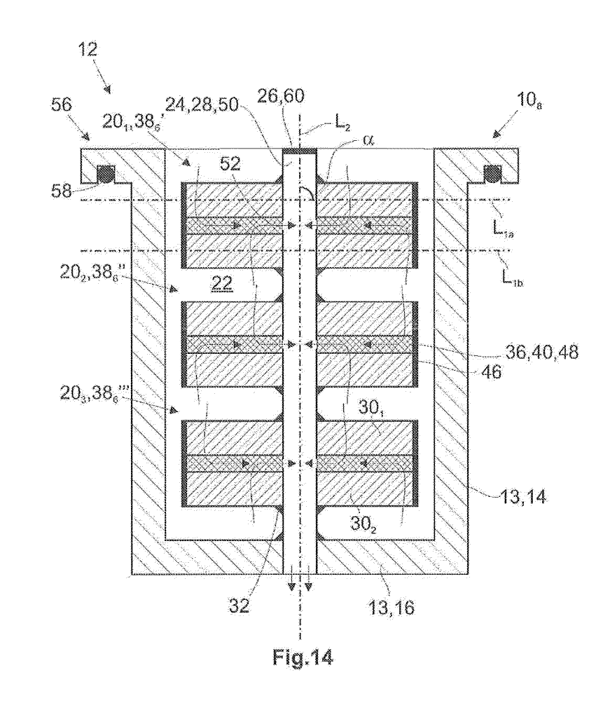

In the exemplary embodiment illustrated in FIG. 10, the container 10₇ is provided with a quadrangular cross-section and three filter units 20₁-20₃ configured as sandwich structures 38₄′-38₄′″, arranged one above the other, which largely correspond to that 38₁ which is shown in FIGS. 6 and 7. However, the container may also be provided with any other desired cross-section and be provided with a different number of sandwich structures 38₄. In this example, the first longitudinal axes L₁ₐ and L_{1b} of the filter bodies 30 do not coincide with the second longitudinal axis L₂ of the container, but rather are at right angles to one another, so that given an intended alignment of a gravity-driven container 10₇, a horizontal orientation of the filter bodies 30 and of the drainage layers 36 and/or the sandwich structures 38₄ results. Departures from the alignment, described here by way of example, of the first and second longitudinal axes L₁ and L₂ are likewise conceivable (cf. FIGS. 14 and 15). As in the other exemplary embodiments having the sandwich structures 38, the outlet 28 adjoins the drainage layer 36. Since the sandwich structures 38 extend essentially horizontally and thus are essentially at right angles to the side wall 14, the outlet 28 extends within the side wall 14.

If water to be treated is now put into the container 10₆, then hydrostatic pressure acts on both filter bodies 30₁ and 30₂ of the sandwich structures 38₄ in the case of purely gravity-driven systems, an excess pressure in the case of pressureoperated systems. Since, as already described further above, atmospheric pressure prevails in the intermediate space between the two filter bodies 30₁ and 30₂, the water to be treated flows through the two filter bodies 30₁ and 30₂ to the drainage layer 36 due to the pressure difference, as indicated by the arrows, wherein it flows through the activated carbon body 30₂ in a direction counter to the effective direction of gravity.

In FIG. 11, a sandwich structure 38 is shown in isolation. As already explained, it comprises the two filter bodies 30₁ and 30₂, which are arranged spaced apart from each other and form an intermediate space 48. In the example illustrated, the drainage layer 36, implemented as a non-woven layer 40, is arranged in the intermediate space 48. in addition, the filter bodies 30₁ and 30₂ are covered by a stabilisation covering 42, which can be implemented as a non-woven covering 44.

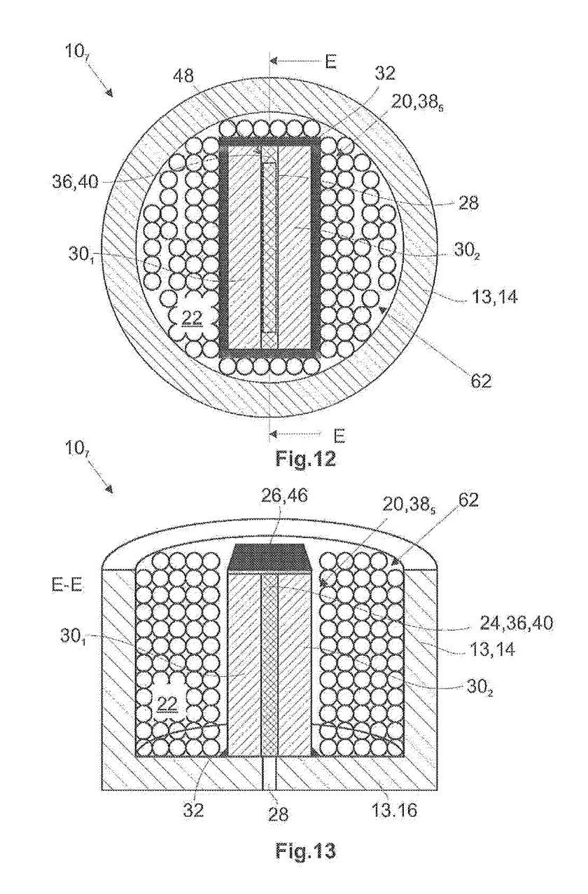

In FIGS. 12 and 13, a further exemplary embodiment of a container 10₇ for treating water is illustrated. This comprises a sandwich structure 38₅, which is connected only to the bottom wall 16, is sealed to the latter by means of the sealing layer 32 and is sealed off with respect to said bottom wall. The sandwich structure 38₅ has no contact with the side wall 14 and covers the outlet 28. Furthermore, the supply section 22 is filled with a granulate 62, which is retained by the filter unit, so that it cannot leave the container 10₇ via the outlet 28.

In FIG. 14, the container 10₈ is configured as a cartridge 12. The essential features of a cartridge are holding means 56, with which the cartridge 12 can be plugged into a cup, not illustrated. The cup is used to collect the filtered water. Furthermore, the container is provided with sealing means 58, which prevent unfiltered water from reaching the cup.

In the example illustrated in FIG. 14, the outlet 28 also comprises a channel 50 having a longitudinal axis L₂, to which channel three sandwich structures 38₆′-38₆′″ having longitudinal axes L₁ₐ and L_{1b} and spaced apart from one another in relation to the longitudinal axis L₂ are attached. The longitudinal axes L₁ₐ and L_{1b} are essentially at right angles to the longitudinal axis L₂, in the area of the drainage layer of the sandwich structures 38₆, the channel 50 is provided with openings 52, through which the filtered water is able to leave the container. Furthermore, the sandwich structures are sealed off with respect to the channel 50 by means of the sealing layers 32, so that no unfiltered water could run along the channel 50 and pass through the openings 52. Furthermore, the sealing layers 32 can have a fixing function, so that they fix the sandwich structures 38₆ to the channel 50. Furthermore, at their end facing away from the channel 50, the sandwich structures are provided with a cover layer 46 which prevents water from passing directly into the drainage layer and there fore through the containers unfiltered. Moreover, at its end facing away from the bottom wall 16, the channel 50 is closed by a closure element 60, so that the water to be filtered cannot flow through the container unfiltered. In this case, the closure element 60 simultaneously also forms the supply means 26, since the effect of the closure element 60 is that the water is supplied only to the supply section of the container.

The first and the second longitudinal axis L₁ and L₂ enclose an angle α, which, in the example illustrated, is 90°. However, it is also possible to vary the angle α between 0 and 90°.

The flow through the sandwich structures 38₆ takes place in an essentially analogous way to that which was described for the exemplary embodiment described in FIG. 10.

### LIST OF REFERENCE SYMBOLS

10 Container
12 Cartridge
13 Wall
14 Side wall
16 Bottom wall
18 Container interior space
20 Filter unit
22 Supply section
24 Discharge section
26 Supply means
28 Outlet
30 Filter body
32 Sealing layer
33 End face
34 Recess
35 Filter area
36 Drainage layer
38 Sandwich structure
40 Sheet structure
42 Stabilisation covering
44 Non-woven covering
46 Cover layer
48 Intermediate space
50 Channel
52 Opening
56 Holding means
58 Sealing means
60 Closure element
62 Granulate
D Thickness of the intermediate layer
g Force of gravity
L₁ First longitudinal axis
L₂ Second longitudinal axis
α Angle enclosed by L₁ and L₂
ρ Layer thickness of the filter body

What is claimed is:

1. A filter unit for treating water, comprising:
a first planar filter body; and
at least one second planar filter body,
wherein the first and the second filter bodies are arranged spaced apart from each other and delimiting an intermediate space, and
wherein each of the first and second filter bodies extends, with reference to a Cartesian coordinate system, over a considerably shorter distance along a first spatial axis than along the two remaining spatial axes, so that it has a layer thickness (ρ),
wherein flow can take place through the first and the second filter body along a path corresponding to the layer thickness.

2. The filter unit according to claim 1, wherein flow can take place through the first and the second filter bodies in the direction of the intermediate space along a path corresponding to the layer thickness.

3. The filter unit according to claim 1, wherein the planar filter bodies are sintered filter bodies.

4. The filter unit according to claim 1, wherein the filter unit is configured in the form of a sandwich structure.

5. The filter unit according to claim 4, wherein the sandwich structure comprises a cover layer for sealing off an end face of the filter body.

6. The filter unit according to claim 5, wherein the cover layer covers and seals off the intermediate space.

7. The filter unit according to claim 1, wherein a drainage layer is arranged in the intermediate space.

8. The filter unit according to claim 7, wherein the drainage layer has a thickness (D) and the layer thickness (ρ) is two to three times as large as the thickness (D).

9. The filter unit according to claim 7, wherein the drainage layer is a sheet structure, a textile sheet structure, or a textile sheet structure made of a non-woven material, a knitted material or a woven material.

10. The filter unit according to claim 9, wherein the sheet structure comprises polyester.

11. The filter unit according to claim 9, wherein the sheet structure comprises fibres which are at least one of chemically and physically active.

12. The filter unit according to claim 1, wherein at least one of the filter bodies is at least partly covered by a stabilisation covering.

13. The filter unit according to claim 1, wherein the planar filter bodies comprise at least one material from the group comprising activated carbon and ion exchange material.

14. The filter unit according to claim 1, wherein at least one of the filter bodies has a permeability (k) that changes within the filter body.

15. The filter unit according to claim 1, wherein the layer thickness (ρ) of at least one of the filter bodies changes along a first longitudinal axis (L₁).

16. The filter unit according to claim 1, wherein at least one of the filter bodies is profiled.

17. The filter unit according to claim 16, wherein at least one of the filter bodies is profiled in a wave-shaped or saw tooth-shaped manner.

18. A container for treating water, comprising at least one filter unit according to claim 1.

19. The container according to claim 18, further comprising:
a wall which delimits a container interior space, wherein the at least one filter unit for filtering the water is arranged in the container interior space and the container interior space is subdivided into a supply section and a discharge section;
a supply for supplying the water to a supply section of the container interior space; and
an outlet arranged at least partly in the wall of the container for carrying off the water out of the discharge section of the container interior space.

20. The container according to claim 19, wherein the supply section is filled with granulate.

21. The container according to claim 19, wherein the filter unit covers the outlet.

22. The container according to claim 19, wherein recesses into which at least one of the filter bodies can be inserted are provided in the wall.

23. The container according to claim 19, wherein a sealing layer is provided between the wall and at least one of the filter bodies.

24. The container according to claim 19, wherein the outlet further comprises a channel extending through the container interior space, to which the at least one filter unit is attached, wherein the channel is provided with openings for carrying off the filtered water.

25. The container according to claim 24, comprising a supporting unit attachable to the channel and communicating with the openings, for arranging the at least one filter unit in the container interior space.

26. The container according to claim 18, wherein the container is configured as a cartridge.

27. The container according to claim 18, wherein the filter bodieshave a first longitudinal axis (L₁) and the container has a second longitudinal axis (L₂), and wherein the first longitudinal axes (L₁) and the second longitudinal axis (L₂) extend essentially in parallel to each other.

28. The container according to claim 18, wherein the filter bodies have a first longitudinal axis (L₁) and the container has a second longitudinal axis (L₂), and wherein the first longitudinal axes (L₁) extend essentially at right angles to the second longitudinal axis (L₂).

29. The container according to claim 18, wherein the filter bodies have a first longitudinal axis (L₁) and the container has a second longitudinal axis (L₂), and wherein the first longitudinal axes (L₁) and the second longitudinal axis (L₂) enclose an angle (α) between 0° and 90°.

30. A method for treating water, comprising the steps of:
treating water, using the filter unit according to claim 1.
